(19) United States
(12) Patent Application Publication
(10) Pub. No.: US 2024/0386107 A1
(43) Pub. Date: Nov. 21, 2024

(54) A COMPUTERIZED CHARGING/INTERFACE DEVICE WITH MALWARE DETECTION AND BACKUP CAPABILITIES

(71) Applicant: B.G. NEGEV TECHNOLOGIES AND APPLICATIONS LTD., AT BEN-GURION UNIVERSITY, Beer Sheva (IL)

(72) Inventors: Mordechai GURI, Nof Ayalon (IL); Yuval ELOVICI, D.N. Lachish Arugot (IL)

(21) Appl. No.: 18/559,944

(22) PCT Filed: May 11, 2022
(86) PCT No.: PCT/IL2022/050490

§ 371 Date: Nov. 9, 2023

Related U.S. Application Data
(60) Provisional application No. 63/186,966, filed on May 11, 2021.
(60) Provisional application No. 63/257,113, filed on Oct. 18, 2021.

(51) Int. Cl. G06F 21/56; G06F 11/14

(52) U.S. Cl. CPC G06F 21/566; G06F 11/1458; G06F 21/567; G06F 2201/805; G06F 2221/034

(57) ABSTRACT

A computerized charger for a mobile device, comprising a charging unit having an AC cord for charging the battery of the mobile device; a communication and power supply cable connected to a charging interface of the mobile device; a processor and associated memory, for implementing a computation device, being capable of performing backup and malware detection operations; one or more software modules or applications, stored in the memory and run by the processor, which are adapted to provide predetermined backup, data transfer and security services to the mobile device, during charging periods of the mobile device.

### FIELD OF THE INVENTION

The present invention relates to the field of smart chargers. More particularly, the invention relates to a computerized interface device such as a charger, for mobile devices, with malware detection and backup capabilities.

### BACKGROUND OF THE INVENTION

Nowadays, there are different kinds of conventional antivirus applications for mobile devices. The operating system of mobile devices, such as smartphones, is manufactured by a manufacturer who gives limited access to files in the mobile files, since the operating system does not give full access to all the files, but only to a part of them.

This limited access is determined due to security reasons. If the antivirus application will get full access to all mobile device files, viruses and malware will also have access to these files. In this case, viruses will be able to penetrate the mobile device's files and cause heavy damage, which can even disable the entire device. The limited access to the files of the mobile device made these conventional antivirus applications limited. Therefore, they are not sufficiently efficient.

The way to access all the files on the mobile device is only through a physical connection by a suitable cable and interface (a USB connection, for example).

Another problem with conventional antivirus applications is the battery power consumption. The battery runs out relatively fast as a result of a running antivirus application. The application runs continuously, consumes computing resources from the mobile device and activates various components (e.g. the processor, the device's memory, etc.) in the device that consume a lot of energy from the battery. For this reason, many users choose not to install an antivirus application on their mobile device, and the device remains unprotected.

Smartphones, tablets and other mobile devices are being charged on a regular basis. The charging is performed via a conventional connecting interface (e.g., a USB connection or via an inductive charging interface). However, these interfaces are able to connect the device to other functionalities, such as a file-system, and internal storage. These interfaces are also able to use the device functionalities while charging the device. However, using these conventional connecting interfaces make the mobile device vulnerable to viruses and malware attacks.

It is therefore an object of the present invention to provide a computerized charging device that has full access to all mobile device files and efficient malware detection capability.

It is another object of the present invention to provide a computerized charging device with malware detection capability, which does not entail large battery (energy) consumption.

It is a further object of the present invention to provide a computerized charging device with malware detection capability, which provides backup and a high level of security.

Other objects and advantages of the invention will become apparent as the description proceeds.

### SUMMARY OF THE INVENTION

A computerized charger for a mobile device, comprising:
a) a charging unit having an AC cord for charging the battery of the mobile device;
b) a communication and power supply cable connected to a charging interface of the mobile device;
c) at least one processor and associated memory, for implementing a computation device, being capable of performing backup and malware detection operations;
d) one or more software modules or applications, stored in the memory and run by the processor, being adapted to provide predetermined backup, data transfer and security services to the mobile device, during charging periods of the mobile device. The communication and power supply cable is a Universal Serial Bus (USB—a hardware interface that supports the exchange of data between a host computer and peripherals) or Micro-USB (is a miniaturized version of the interface) cable.

The services provided to the mobile device during charging, are one or more of the following:
offline backup of files and applications;
online backup of files and applications;
malware scanning.

An offline backup may be performed on an offline storage device.

The offline storage device may be a Disk-On-Key or a memory stick.

The backup operation may be full or incremental.

The storage device may be integrated into the computerized charger or may be an external storage hardware device.

An online backup may be performed by uploading files and applications to a remote server or to a computational cloud.

The communication channel for data transfer, storage and retrieval between the computerized charger and an online storage medium may be a wireless channel.

The computerized charger may be adapted to provide backup of the internal firmware, the OS, and installed applications, which is done automatically, or based on the user's request.

Malware scanning may be done at the application level and/or at the Operating System (OS) level.

The computerized charger may be adapted to delete or quarantine suspicious detected files.

Scanning may be done based on one or more of the following:
connection to a signature database containing typical signatures of known viruses or malware);
statical analysis;
dynamic analysis;
heuristic methods.

The computerized charger may be adapted to upload files to be scanned to a remote server or to a computational cloud, to perform remote scanning and analysis.

The computerized charger may be adapted to perform, during charging, scanning and/or integrity check on bootloaders and/or firmware images in the mobile device.

The computerized charger may be adapted to:
issue warnings and indications to the user regarding malicious files;
delete suspected files;
block the operation of suspected files;
clean malicious applications;
perform updates.

Indications about malware may be visual or voice indications.

The computerized charger may be used as a security token that upon connecting between them and following a dedicated paring process, is transferred to the mobile device and applies predetermined policy rules.

The computerized charger may be adapted to transfer stored data between different mobile devices and may be used as a debugging interface.

The computerized charger may be adapted to access low-level storage information from the boot-loader, the kernel and the operating system of the mobile device, to perform forensic investigation and backups.

The computerized charger may be adapted to interface with a user via a touch screen, an external screen, or via other external devices identified by the charger.

The inherent interface of the mobile device may be used to interface with the user.

The charging unit wirelessly charges the mobile device.

The computerized charger may further comprise short-range networking capabilities.

The computerized charger may be adapted to receive credentials from the mobile device to connect to the computational cloud.

The computerized charger may be adapted to be paired with several mobile devices.

The mobile device may be: a smartphone, a wearable smartwatch, or smart glasses.

The charging interface of the mobile device may be a socket for wired charging or a wireless charging interface.

The computerized charger may further comprise one or more dedicated software applications to be run by the OS and its computational resources, for providing external trusted services to the mobile device.

The dedicated software application may be selected from the group of:
a token for authenticating transactions made by the mobile device.
An application to provide high-level encryption to the user's digital or electronic
Applications developed by external providers, to be used by the mobile device.
dedicated antivirus for the mobile device;
keys of a trusted e-wallet;
updating the OS of the mobile device.

A dongle for a mobile device, comprising:
a) a wired or wireless interface to be coupled to a port of the mobile device;
b) at least one processor and associated memory, for implementing a computation device, being capable of performing backup and malware detection operations;
c) one or more software modules or applications, stored in the memory and run by the processor, being adapted to provide predetermined backup, data transfer and security services to the mobile device, upon connection to the mobile device via the wired or wireless interface.

The interface may be a wired interface via a socket in the mobile device.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 shows a block diagram of the smart-charger of the present invention, and the connectivity of the smart charger to other systems.

### DETAILED DESCRIPTION OF THE INVENTION

The present invention provides a computerized charging device (“a smart charger”) that has full access to all mobile device files and efficient malware detection capability that does not entail large battery (energy) consumption. The computerized charging device is also adapted to provide backup and a high level of security, as well as other functionalities regarding the maintenance, backup and security of the device.

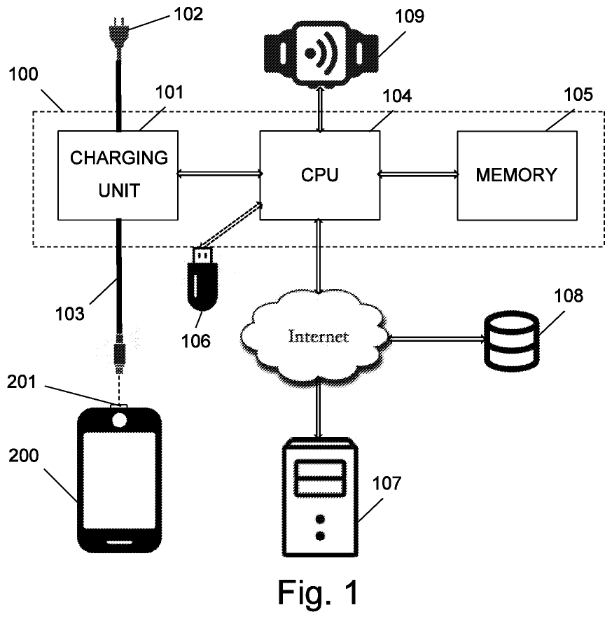

FIG. 1 is a block diagram of the smart charger provided by the present invention. The smart charger 100 comprises a standard charging unit which is connected by an AC cord to the AC power line and converts the AC power to charging DC power that is fed via a communication and power supply cable 103 (such as USB) into the charging socket 201 of a mobile device 200.

The smart charger 100 also comprises a processor 104 and memory 105 which implement a computation device (a kind of a portable computer) that is capable of performing backup operations and malware detection. The CPU 104 is coupled to the communication and power supply cable 103 and therefore, has direct and full access to all files in the mobile device 200.

CPU 104 runs several software modules or applications, which are stored in the memory 105 and are adapted to carry out one or more of the following services:

### Offline Backup

When the smart-charger 100 is connected to the mobile device 200, it starts charging its battery. During charging, the CPU 104 performs a backup of the file system of the mobile device to an offline storage device, such as a Disk-On-Key (or a USB flash drive-a data storage device that includes flash memory with an integrated USB interface) or a memory stick (a proprietary removable flash memory card format created by Sony Corporation). The backup operation may be full (i.e., storing all files) or incremental (i.e., storing only new files). The storage device may be integrated into the charger 100 or may be inserted as an external storage device 106 into a mating socket (such as a USB).

### Online Backup

During charging of the mobile device 200 by the smart-charger 100 the CPU 104 performs an online backup of the file system of the mobile device to an online storage medium, such as a remote server 107. Here also, the backup operation may be full (i.e., storing all files) or incremental (i.e., storing only new files). Data to be stored may be uploaded online, to a computational cloud (not shown). The communication channel for data transfer (storage and retrieval) between the smart-charger 100 and the online storage medium may be, for example, a wireless channel, such as a WiFi connection (using a dedicated WiFi chip). The Wi-Fi chip being used is either integrated into the smart-charger or as part of the device. In both modes, the smart-charger 100 will be adapted to provide backup of the internal firmware (a specific class of computer software that provides the low-level control for a device's specific hardware), the OS, and installed applications. The backups may be done automatically, or based on the user's request.

The smart charger 100 may include dedicated software applications that will be installed and run, using its computational resources. For example, a dedicated software application may be a token for authenticating transactions made by the mobile device.

According to another embodiment, a dedicated software application is used to provide high-level encryption to the user's digital or electronic wallet (a digital wallet (or e-wallet) is a software-based system that securely stores users' payment information and passwords for numerous payment methods and websites. By using a digital wallet, users can complete purchases easily and quickly with near-field communications technology. Digital wallets can be used in conjunction with mobile payment systems, which allow customers to pay for purchases with their smartphones).

Since the smart-charger 100 has access to all the files on the mobile device, the smart-charger 100 may be used by application providers to develop better applications to be used by the mobile device. For example, an antivirus provider may use the smart-charger 100 as a platform for developing a more reliable antivirus for the mobile device, based on the entire file system of the mobile device, which is now accessible e.g., via an API of the OS of the smart-charger 100.

Such dedicated applications are more trusted than applications that reside on the mobile device, since the smart-charger 100 is a type of trusted device. For example, applications for biometric authentication will be much less vulnerable when residing on the smart-charger 100 and may be used for transactions that require high-level security (such as transactions that involve a large amount of money). In this example, upon connecting the mobile device to the smart-charger 100, a user will be able to introduce his biometric data (e.g., a fingerprint) to a biometric sensor in the smart-charger 100 (rather than to a biometric sensor in his mobile device).

In another embodiment, the keys used to authenticate e-wallet transactions will be stored on the smart-charger 100 (rather than on the mobile device) and therefore, will be more protected.

In another embodiment, the smart-charger will be able to update the OS of the mobile device.

### Malware Scanning

In this mode, the smart-charger 100 is connected to the device and while charging, for performing malware scanning of the file system. Scanning is done at the application level and/or at the Operating System (OS) level. The smart-charger 100 may be adapted to delete or quarantine (the process of isolating a file suspected of being infected with a virus to a specific area of a storage device in order to prevent it from contaminating other files) suspicious files, if required for assuring a high level of data security. Scanning may be done based on connection to a signature database 108 (which contains typical signatures of known viruses or malware), statical analysis, dynamic analysis, heuristic methods and so on. The smart-charger 100 may be adapted to upload files to be scanned to a remote server or a computational cloud, in order to perform remote scanning and analysis.

According to another embodiment of the invention, during charging, the smart-charger 100 performs scanning and/or integrity check (integrity check protects system files against unauthorized modifications) on bootloaders (software that is responsible for booting the computer) and/or other firmware images (the firmware image is a binary that may contain the complete software of a device or a subset of it).

Following the above operations, the smart-charger 100 may be adapted to issue warnings and indications to the user (regarding malicious files), delete suspected files, block their operations, to clean malicious applications, to perform software updating, and so on. For example, indications about malware may be provided visually, using a Light-Emitting Diode (LED-which may emit red light upon detecting malware in the files system or the applications of the mobile device 200).

According to another embodiment of the invention, the smart-charger 100 is used as a security token (a portable device that authenticates a person's identity electronically by storing some sort of personal information) that is transferred to the mobile device 200, upon connecting between them and following a dedicated paring process. If the token is found to be unknown, the mobile device 200 will be locked. The policy rules of locking the mobile device 200 may be determined by the smart-charger 100 and/or by the mobile device 200. For example, if the mobile device 200 is stolen, there will be no possibility to charge it with another charger. Alternatively, if the paired smart-charger 100 will not be connected to the mobile device for a predetermined period, the mobile device 200 will be locked.

According to another embodiment of the invention, the smart-charger 100 is used for transferring stored data between devices. For example, if an old mobile device 200 of a user should be replaced by a new mobile device, the smart-charger 100 will copy or move the data to the new mobile device, such that the new mobile device will be ready for use with the same configuration.

According to another embodiment of the invention, the smart-charger 100 is used as a debugging interface by connecting it to the mobile device 200 and scanning the memory of the mobile device 200 for malware or other activities.

According to another embodiment of the invention, the smart-charger 100 is used for forensic investigation by connecting it to the mobile device 200 and accessing the low-level storage information from the boot-loader, kernel (the main layer between the OS and hardware and being core that provides basic services for all other parts of the OS), and operating system to perform forensic investigation (finding evidence of a data breach and the security vulnerabilities that enabled it) and backups.

The smart-charger 100 may interface with the user via a dedicated touch screen, an external screen, or via other external devices identified by the charger, such as a laptop, a tablet, a computer, or other mobile devices. In addition, The smart-charger 100 may use the inherent interface of the mobile device 200 (loudspeaker, microphone, display and keypad) to interface with the user.

According to another embodiment of the invention, the charging unit of the smart-charger 100 is adapted to wirelessly charge the mobile device 200 (e.g., by inductive charging). In this embodiment, the power supply cable 103 will be used only for data communication.

According to another embodiment of the invention, the smart-charger 100 comprises a loudspeaker and/or a microphone for interfacing with the user and providing audio alerts. The smart-charger 100 may also comprise short-range networking capabilities, such as Wi-Fi and Bluetooth.

According to another embodiment of the invention, the smart-charger 100 is adapted to receive credentials from the mobile device 200 to connect to the cloud and may be used as logging storage to generate a log of the activity of the mobile device 200.

According to another embodiment of the invention, the smart-charger 100 is adapted to be paired with several mobile devices, such as mobile devices of a family, in order to be able to charge each of them and support them with the backup and scanning services described above.

The mobile device 200 may be a smartphone, a wearable smartwatch 109 (a wearable computer in the form of a watch) or smart glasses (wearable computer glasses that add information alongside or to what the wearer sees). This also includes any wearable device in any form that is connected to a data network.

According to another embodiment, the trusted device may be a dongle (computer hardware that connects to a port of the mobile device to provide it with additional functionality) which is an interface device that does not have charging functionality, but has access to the entire file system of the mobile device. In this case, the dongle or interface device will have all the functionalities of the smart-charger 100 described above.

As various embodiments and examples have been described and illustrated, it should be understood that variations will be apparent to one skilled in the art without departing from the principles herein. Accordingly, the invention is not to be limited to the specific embodiments described and illustrated in the drawings.

1. A computerized charger for a mobile device, comprising:
a) a charging unit having an AC cord for charging the battery of said mobile device;
b) a communication and power supply cable connected to a charging interface of said mobile device;
c) at least one processor and associated memory, for implementing a computation device, being capable of performing backup and malware detection operations; and
d) one or more software modules or applications, stored in said memory and run by said processor, being adapted to provide predetermined backup, data transfer and security services to said mobile device, during charging periods of said mobile device.

2. A dongle interface device for a mobile device, comprising:
a) a wired or wireless interface to be coupled to a port of said mobile device;
b) at least one processor and associated memory, for implementing a computation device, being capable of performing backup and malware detection operations; and
c) one or more software modules or applications, stored in said memory and run by said processor, being adapted to provide predetermined backup, data transfer and security services to said mobile device, upon connection to said mobile device via said wired or wireless interface.

3. A computerized charger according to claim 1, wherein the communication and power supply cable is a USB or micro-USB cable.

4. A computerized charger according to claim 1, wherein the services provided to the mobile device during charging are one or more of the following:
offline backup of files and applications;
online backup of files and applications; or
malware scanning.

5. A computerized charger according to claim 4, wherein offline full or incremental backup is performed into an offline storage device, the offline storage device being a Disk-On-Key or a memory stick.

6. (canceled)

7. (canceled)

8. A computerized charger according to claim 4, wherein the storage device is integrated into the computerized charger or is an external storage hardware device.

9. (canceled)

10. A computerized charger according to claim 4, wherein online full or incremental backup is performed by uploading files and applications to a remote server or to a computational cloud.

11. A computerized charger according to claim 4, wherein the communication channel for data transfer, storage and retrieval between the computerized charger and an online storage medium is a wireless channel.

12. A computerized charger according to claim 4, wherein the computerized charger is adapted to provide a backup of the internal firmware, the OS, and installed applications, which is done automatically, or based on the user's request.

13. A computerized charger according to claim 4, wherein malware scanning is done at the application level and/or at the Operating System (OS) level.

14. A computerized charger according to claim 13, being adapted to perform one or more of the following operations:
delete or quarantine suspicious detected files;
upload files to be scanned to a remote server or to a computational cloud to perform remote scanning and analysis;
during charging, scan and/or check the integrity on bootloaders and/or firmware images in the mobile device;
issue warnings and indications to the user regarding malicious files;
delete suspected files;
block the operation of suspected files;
clean malicious applications;
perform software updates;
transfer stored data between different mobile devices;
access low-level storage information from the boot-loader, kernel and operating system of the mobile device to perform forensic investigation and backups;
interface with a user via a touch screen, an external screen or via other external devices identified by the charger; or
receive credentials from the mobile device to connect to the computational cloud;
be paired with several mobile devices.

15. A computerized charger according to claim 14, wherein scanning is done based on one or more of the following:
connection to a signature database containing typical signatures of known viruses or malware);
statical analysis;
dynamic analysis; or
heuristic methods.

16. (canceled)

17. (canceled)

18. (canceled)

19. A computerized charger according to claim 18, wherein indications about malware are visual or voice indications.

20. (canceled)

21. (canceled)

22. A computerized charger according to claim 4, being used as a debugging interface or as a security token that, upon connecting between them and following a dedicated paring process, is transferred to the mobile device and applies predetermined policy rules.

23. (canceled)

24. (canceled)

25. A computerized charger according to claim 1, the inherent interface of the mobile device is used to interface with the user.

26. A computerized charger according to claim 1, wherein the charging unit wirelessly charges the mobile device.

27. (canceled)

28. (canceled)

29. (canceled)

30. A computerized charger according to claim 1, wherein the mobile device is one of the following:
a smartphone;
a wearable smartwatch; or
smart glasses.

31. A computerized charger according to claim 1, wherein the charging interface of the mobile device is a socket for wired charging or a wireless charging interface.

32. A computerized charger according to claim 1, further comprising one or more of the following:
one or more dedicated software applications to be run by the OS and its computational resources, for providing external trusted services to the mobile device; or
short-range networking capabilities.

33. A computerized charger according to claim 32, wherein the dedicated software application is selected from the group of:
a token for authenticating transactions made by the mobile device;
an application to provide high-level encryption to the user's digital or electronic;
applications developed by external providers, to be used by the mobile device;
dedicated antivirus for the mobile device;
keys of a trusted e-wallet; or
updating the OS of the mobile device.

34. (canceled)
